(19) United States
(12) Patent Application Publication
(10) Pub. No.: US 2026/0330912 A1
(43) Pub. Date: Oct. 22, 2026

(54) BANKNOTE COUNTING AND COUNTERFEIT DETECTION MACHINE

(71) Applicant: Weimin ZHANG, Wenzhou (CN)

(72) Inventor: Weimin ZHANG, Wenzhou (CN)

(21) Appl. No.: 19/237,055

(22) Filed: Jun. 13, 2025

(30) Foreign Application Priority Data
Apr. 22, 2025 (CN) 202520764144.8

(51) Int. Cl. G07D 11/175; G07D 7/1205; G07D 11/50

(52) U.S. Cl. CPC G07D 11/175; G07D 7/1205; G07D 11/50; G07D 2207/00; G07D 2211/00

(57) ABSTRACT

A banknote counting and counterfeit detection machine includes two side panels, where a feed mechanism, a counterfeit detection mechanism, and a discharge mechanism are arranged between the two side panels; the counterfeit detection mechanism includes pressure rollers, a banknote conveying platform, a mounting frame, upper optical detection components, and lower optical detection components; a banknote conveying passage is formed between the pressure rollers and the banknote conveying platform; the mounting frame is connected to the two side panels, and longitudinally extends to form a mounting plate; the upper optical detection components are disposed on the mounting plate; the lower optical detection components are located at an outlet end of the banknote conveying passage; and the lower optical detection components and the upper optical detection components are arranged in a one-to-one correspondence and operate cooperatively. The banknote is flattened when reaching the outlet end of the banknote conveying passage.

### CROSS REFERENCE TO THE RELATED APPLICATIONS

This application is based upon and claims priority to Chinese Patent Application No. 202520764144.8, filed on Apr. 22, 2025, the entire contents of which are incorporated herein by reference.

### TECHNICAL FIELD

The present disclosure relates to a banknote counting and counterfeit detection machine.

### BACKGROUND

In existing banknote counting and counterfeit detection machines, the signal transmitter and receiver are arranged between the feed roller and the pressure roller to authenticate banknotes through optical detection. To ensure accuracy of optical detection, an additional conveying roller is needed to flatten the banknotes. However, when the pressure roller and the conveying roller simultaneously contact the banknote, the banknote is pulled taut, resulting in inaccurate identification.

### SUMMARY

In view of the technical problems mentioned in the background section, the present disclosure aims to provide a banknote counting and counterfeit detection machine. The present disclosure performs optical detection on banknotes at an outlet end of a banknote conveying passage, ensuring high accuracy of counterfeit detection.

To solve the above technical problem, the present disclosure adopts the following technical solution. A banknote counting and counterfeit detection machine includes two side panels, where a feed mechanism, a counterfeit detection mechanism, and a discharge mechanism are arranged between the two side panels; the counterfeit detection mechanism is connected between the feed mechanism and the discharge mechanism; a conveying direction of the counterfeit detection mechanism is longitudinal; the counterfeit detection mechanism includes pressure rollers and a banknote conveying platform; the pressure rollers are arranged at intervals along an axial direction of a rotating shaft; the rotating shaft is rotatably disposed between the two side panels; a banknote conveying passage is formed between the pressure rollers and the banknote conveying platform; the counterfeit detection mechanism further includes: a mounting frame, upper optical detection components, and lower optical detection components; the mounting frame is connected to the two side panels; the mounting frame longitudinally extends to form a mounting plate; the mounting plate is provided with a first notch for the pressure roller to pass through; the upper optical detection components are disposed on the mounting plate, and are arranged transversely; the lower optical detection components are disposed on the banknote conveying platform and located at an outlet end of the banknote conveying passage; and the lower optical detection components and the upper optical detection components are arranged in a one-to-one correspondence and operate cooperatively.

In this solution, between the upper optical detection component and the lower optical detection component, one component transmits an optical signal, and the other component receives the optical signal passing through the banknote. The variation of the optical signal is utilized to identify the banknote. The banknote is flattened when reaching the outlet end of the banknote conveying passage, thereby achieving accurate identification.

Preferably, the counterfeit detection mechanism further includes a magnetic head; the banknote conveying platform is provided with a second notch; the magnetic head extends into the banknote conveying passage through the second notch; and a banknote conveying gap is formed between the magnetic head and the pressure rollers.

In this solution, the magnetic head detects magnetic features of the banknotes, and it is combined with optical detection to ensure identification accuracy.

Preferably, auxiliary rollers are provided on the rotating shaft; a roller is arranged below the auxiliary roller; and the banknote conveying platform is provided with a third notch for the roller to pass through.

In this solution, for too long banknotes, the auxiliary rollers are matched with the rollers to press two sides of the banknotes and convey the banknotes, thereby adapting to different currencies.

Preferably, the upper optical detection components are transmission receivers; the lower optical detection component includes a light source emission lamp; and the light source emission lamp includes an infrared lamp.

In this solution, the transmission receiver receives the optical signal emitted by the light source emission lamp through the banknote, and whether the banknote is genuine is determined based on an image.

Preferably, the light source emission lamp further includes a color lamp.

In this solution, color lamps are arranged for supplementary lighting, such that the optical signal received by the transmission receiver can achieve clear identification.

Preferably, the color lamp is a white lamp.

In this solution, the white lamp has the best supplementary lighting effect.

Preferably, the lower optical detection component further includes a reflection receiver.

In this solution, the reflection receiver receives the light emitted by the light source emission lamp and reflected by the banknote, and the denomination of the banknote is identified based on an image.

Preferably, the mounting plate is located below the rotating shaft.

In this solution, the spacing between the upper optical detection component and the lower optical detection component is short, so the intensity of the optical signal is sufficiently high.

Preferably, the lower optical detection component includes a light source emission lamp; the light source emission lamp includes infrared lamps; there are at least 21 infrared lamps; and spacing between adjacent infrared lamps is 7-9 mm.

In this solution, this arrangement utilizes limited mounting space, so the optical signal received by the receiver is sufficiently comprehensive.

The present disclosure has the following beneficial effects. Between the upper optical detection component and the lower optical detection component, one component transmits an optical signal, and the other component receives the optical signal passing through the banknote. The variation of the optical signal is utilized to identify the banknote. The banknote is flattened when reaching the outlet end of the banknote conveying passage, thereby achieving accurate identification. Therefore, the present disclosure has substantial features and improvements compared with prior art.

### BRIEF DESCRIPTION OF THE DRAWINGS

According to the drawings, the relevant details and working principles of the implementations and embodiments of the present disclosure are described as follows.

FIG. 1 is a three-dimensional structural schematic diagram according to the present disclosure; and

FIG. 2 is an enlarged view of A shown in FIG. 1.

Reference Numerals: 1. side panel; 2. feed mechanism; 3. counterfeit detection mechanism; 4. discharge mechanism; 5. pressure roller; 6. banknote conveying platform; 7. rotating shaft; 8. mounting frame; 9. mounting plate; 10. auxiliary roller; and 11. magnetic head.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are merely a part rather than all of the embodiments of the present disclosure. All other embodiments derived from the embodiments in the present disclosure by those of ordinary skill in the art without creative efforts should fall within the protection scope of the present disclosure.

In the description of the present disclosure, it needs to be understood the orientation or positional relationships indicated by terms such as “upper” and “lower” are based on the orientation or positional relationship shown in the drawings. They are merely intended to facilitate and simplify the description of the present disclosure, rather than to indicate or imply that the apparatus or element referred to must have a particular orientation or be constructed and operated in a particular orientation. Therefore, these terms should not be interpreted as limiting the present disclosure.

In the description of the present disclosure, the terms such as “first” and “second” are only for the purpose of description and should not be construed as indicating or implying relative importance, or implicitly indicating the quantity of indicated technical features.

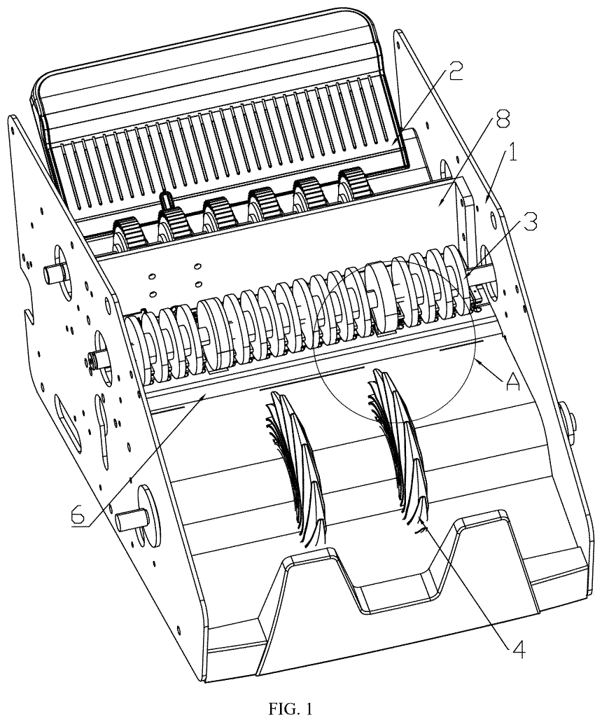

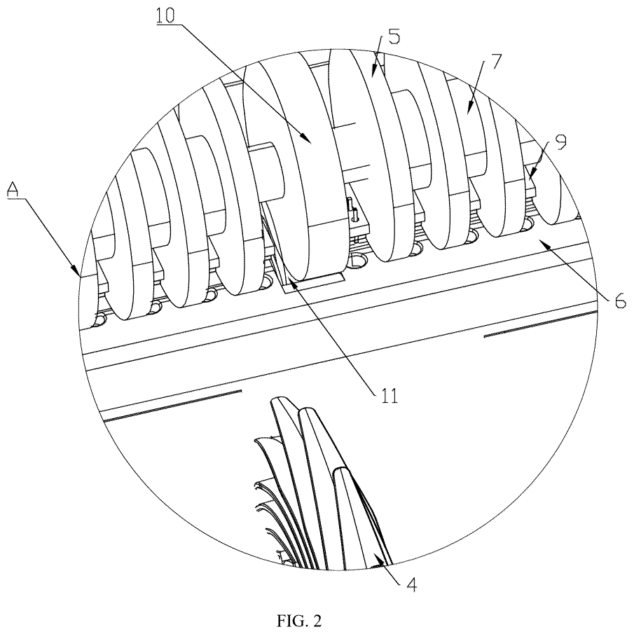

Referring to FIG. 1 and FIG. 2, in an embodiment of the implementation, a banknote counting and counterfeit detection machine includes two side panels 1. Feed mechanism 2, counterfeit detection mechanism 3, and discharge mechanism 4 are arranged between the two side panels 1. The counterfeit detection mechanism 3 is connected between the feed mechanism 2 and the discharge mechanism 4. A conveying direction of the counterfeit detection mechanism 3 is longitudinal. The counterfeit detection mechanism 3 includes pressure rollers 5 and banknote conveying platform 6. The pressure rollers 5 are arranged at intervals along an axial direction of rotating shaft 7. The rotating shaft 7 is rotatably disposed between the two side panels 1. A banknote conveying passage is formed between the pressure rollers 5 and the banknote conveying platform 6. Auxiliary rollers 10 are provided on the rotating shaft 7. A roller is arranged below the auxiliary roller 10. The banknote conveying platform 6 is provided with a third notch for the roller to pass through.

The counterfeit detection mechanism 3 includes mounting frame 8, upper optical detection components, and lower optical detection components. The mounting frame 8 is connected to the two side panels 1. The mounting frame 8 longitudinally extends to form mounting plate 9. The mounting plate 9 is located below the rotating shaft 7. The mounting plate 9 is provided with a first notch for the pressure roller 5 to pass through. The upper optical detection components are disposed on the mounting plate 9. The upper optical detection components are arranged transversely. The lower optical detection components are disposed on the banknote conveying platform 6 and located at an outlet end of the banknote conveying passage. The lower optical detection components and the upper optical detection components are arranged in a one-to-one correspondence and operate cooperatively. The upper optical detection components are transmission receivers. The lower optical detection component includes a light source emission lamp and a reflection receiver. The light source emission lamp includes an infrared lamp and a color lamp. The color lamp is a white lamp.

In the implementation, banknotes enter from the feed mechanism 2, pass through the counterfeit detection mechanism 3, and reach the discharge mechanism 4. The pressure rollers 5 rotate to convey the banknotes backward. The infrared lamp and the color lamp form a combined light source. A transmission receiver receives an optical signal transmitted through a banknote surface to identify the banknote. The reflection receiver receives an optical signal reflected from the banknote surface to identify a denomination of the banknote. The design is applicable to banknote identification for different countries and different denominations. The auxiliary rollers 10 divide the pressure rollers 5 into three groups. The feed mechanism 2 and the discharge mechanism 4 are mature technologies.

In other alternative implementations, the upper optical detection component and the lower optical detection component may be exchangeable in mounting positions, and the color lamps may be replaced with other colors.

Furthermore, the counterfeit detection mechanism 3 further includes a magnetic head 11. The banknote conveying platform 6 is provided with a second notch. The magnetic head 11 extends into the banknote conveying passage through the second notch. A banknote conveying gap is formed between the magnetic head 11 and the pressure rollers 5.

In this implementation, the magnetic head 11 detects magnetic features of the banknotes, and it is combined with optical detection to ensure identification accuracy.

Furthermore, the lower optical detection component includes a light source emission lamp. The light source emission lamp includes infrared lamps. There are at least 21 infrared lamps, and spacing between adjacent infrared lamps is 7-9 mm.

In this implementation, the overall structure of the device is compact. Sufficient infrared lamps are arranged in limited space to fully identify anti-counterfeiting features on banknote surfaces.

The above described are preferred implementations of the present disclosure, but it should be noted that the protection scope of the present disclosure is not limited thereto. It should be understood that, for those skilled in the art, multiple modifications, refinements, or equivalent substitutions can be made to the present disclosure without departing from the technical scope of the present disclosure and under the premise of maintaining equivalent inventive concepts of the present disclosure. However, such refinements, or equivalent substitutions should also be deemed to fall within the protection scope of the present disclosure.

What is claimed is:

1. A banknote counting and counterfeit detection machine, comprising two side panels, wherein a feed mechanism, a counterfeit detection mechanism, and a discharge mechanism are arranged between the two side panels; the counterfeit detection mechanism is connected between the feed mechanism and the discharge mechanism; a conveying direction of the counterfeit detection mechanism is longitudinal; the counterfeit detection mechanism comprises pressure rollers and a banknote conveying platform; the pressure rollers are arranged at intervals along an axial direction of a rotating shaft; the rotating shaft is rotatably disposed between the two side panels; a banknote conveying passage is formed between the pressure rollers and the banknote conveying platform; and the counterfeit detection mechanism further comprises:
a mounting frame, connected to the two side panels, wherein the mounting frame longitudinally extends to form a mounting plate; and the mounting plate is provided with a first notch for the pressure roller to pass through;
upper optical detection components, disposed on the mounting plate and arranged transversely; and
lower optical detection components, disposed on the banknote conveying platform and located at an outlet end of the banknote conveying passage, wherein the lower optical detection components and the upper optical detection components are arranged in a one-to-one correspondence and operate cooperatively.

2. The banknote counting and counterfeit detection machine according to claim 1, wherein the counterfeit detection mechanism further comprises a magnetic head; the banknote conveying platform is provided with a second notch; the magnetic head extends into the banknote conveying passage through the second notch; and a banknote conveying gap is formed between the magnetic head and the pressure rollers.

3. The banknote counting and counterfeit detection machine according to claim 1, wherein auxiliary rollers are provided on the rotating shaft; a roller is arranged below the auxiliary roller; and the banknote conveying platform is provided with a third notch for the roller to pass through.

4. The banknote counting and counterfeit detection machine according to claim 1, wherein the upper optical detection components are transmission receivers; the lower optical detection component comprises a light source emission lamp; and the light source emission lamp comprises an infrared lamp.

5. The banknote counting and counterfeit detection machine according to claim 4, wherein the light source emission lamp further comprises a color lamp.

6. The banknote counting and counterfeit detection machine according to claim 5, wherein the color lamp is a white lamp.

7. The banknote counting and counterfeit detection machine according to claim 4, wherein the lower optical detection component further comprises a reflection receiver.

8. The banknote counting and counterfeit detection machine according to claim 1, wherein the mounting plate is located below the rotating shaft.

9. The banknote counting and counterfeit detection machine according to claim 3, wherein the lower optical detection component comprises a light source emission lamp; the light source emission lamp comprises at least 21 infrared lamps; and a spacing between adjacent infrared lamps is 7-9 mm.
